(19) United States
(12) Patent Application Publication
(10) Pub. No.: US 2026/0302796 A1
(43) Pub. Date: Oct. 1, 2026

(54) CHARGING AND DISCHARGING MANAGEMENT DEVICE AND CHARGING AND DISCHARGING MANAGEMENT METHOD

(71) Applicant: HONDA MOTOR CO., LTD., Tokyo (JP)

(72) Inventor: Seiya Nagase, Tokyo (JP)

(21) Appl. No.: 19/534,826

(22) Filed: Feb. 10, 2026

(30) Foreign Application Priority Data
Mar. 27, 2025 (JP) 2025-053482

(51) Int. Cl. H02J 3/466; B60L 53/65; B60L 53/66; B60L 53/67; B60L 55/00; B60L 58/12; H02J 3/17; H02J 103/35

(52) U.S. Cl. CPC H02J 3/466; B60L 53/65; B60L 53/66; B60L 53/67; B60L 55/00; B60L 58/12; H02J 3/17; H02J 2103/35

(57) ABSTRACT

A charging and discharging management device includes a demand-response-request-reception-part, a vehicle-information-acquisition-part, a priority-determining-part configured to determine priority of a vehicle equipped with a battery that controls charging and discharging according to a request of demand response, a resource-calculation-part configured to calculate an amount of resources of electric power secured in the demand response, and a resource-priority-determining-part configured to determine resource priority that secures the amount of resources in demand response, the priority-determining-part determining the priority based on at least a number of days elapsed from the demand response in which the vehicle previously participated, information on a participation rate in a past demand response, and the amount of resources secured in the demand response in which the vehicle currently participates, and the resource priority-determining-part determining the resource priority based on the priority, and a state of charge of the battery of the vehicle that currently participates in the demand response.

### CROSS-REFERENCE TO RELATED APPLICATION

Priority is claimed on Japanese Patent Application No. 2025-053482, filed Mar. 27, 2025, the content of which is incorporated herein by reference.

### BACKGROUND OF THE INVENTION

### Field of the Invention

The present invention relates to a charging and discharging management device and a charging and discharging management method.

### Description of Related Art

In recent years, research has been underway into a demand response (hereinafter referred to as “DR”) mechanism that balances electric power demand and supply by utilizing vehicle-to-grid (V2G) technology, which supplies electric power from batteries installed in vehicles to an electric power system, and controlling charging and discharging of batteries installed in vehicles. For this reason, in the related art, technologies related to systems that realize DR in vehicles have been proposed (for example, see Japanese Unexamined Patent Application, First Publication No. 2022-115360 or U.S. Pat. No. 11,239,660). In the related art, the priority of vehicles to participate in the DR about to be implemented is determined based on information such as participation history of a plurality of vehicles in past DRs and whether or not their participation in DRs was successful.

### SUMMARY OF THE INVENTION

However, in the related art, although the priority of the vehicles participating in the DR is determined, no consideration was given to the order in which the vehicles selected based on priority should respond to the DR. Further, in the related art, no consideration was given to the processing contents involved in making each vehicle comply with the DR, such as how much electric power should be provided to each vehicle selected based on priority, or what processing should be used to make the vehicle comply with the DR.

Incidentally, it is known that maintenance time of a state of charge (SOC) of a battery installed in a vehicle influences the deterioration in capacity retention rate of the battery, that is, the deterioration in state of health (SOH) of the battery. More specifically, it is known that batteries with very high or very low SOC tend to deteriorate more rapidly. However, in the related art, the SOH of the battery, which is influenced by the SOC, was also not taken into consideration. For this reason, participating in DR has resulted in the control of battery charging and discharging, which can sometimes cause disadvantages to users when using their vehicles, such as accelerating the deterioration of the battery installed in the vehicle.

An aspect of the present invention is directed to providing a charging and discharging management device and a charging and discharging management method that are capable of appropriately determining priority for vehicles participating in demand response.

A charging and discharging management device and a charging and discharging management method according to the present invention employ the following configurations.
(1) A charging and discharging management device according to an aspect of the present invention is a charging and discharging management device configured to manage demand response that adjusts electric power supply and demand in an electric power system by controlling charging and discharging of batteries installed in a plurality of vehicles that are electrically connectible to the electric power system, the charging and discharging management device including: a demand response request reception part configured to receive a request of the demand response; a vehicle information acquisition part configured to acquire information of each of the vehicles and the batteries; a priority determining part configured to determine priority of the vehicle equipped with the battery that controls the charging and discharging according to a request of the demand response; a resource calculation part configured to calculate an amount of resources of electric power secured in the battery of the vehicle that participates in the demand response; and a resource priority determining part configured to determine resource priority that secures the amount of resources in the battery of the vehicle that participates in the demand response, wherein the priority determining part determines the priority based on at least a number of days elapsed from the demand response in which the vehicle previously participated, information on a participation rate of the vehicle in a past demand response, and the amount of resources secured in the demand response in which the vehicle currently participates, and the resource priority determining part determines the resource priority based on the priority, and a state of charge of the battery contained in information of the battery of the vehicle that currently participates in the demand response.
(2) In the aspect of the above-mentioned (1), when the demand response is a first demand response that reduces consumption of electric power in the electric power system, the resource priority determining part sets the resource priority of the battery, in which a charging and discharging control method in response to the first demand response is a second control method that reduces the amount of electric power being charged, higher than the resource priority of the battery, in which the charging and discharging control method is a first control method that increases the discharge amount of stored electric power, and sets a final resource priority of the battery whose state of charge is equal to or greater than a first high state of charge value, in which the method is the first control method, higher than the final resource priority of the battery, in which the method is the second control method.
(3) In the aspect of the above-mentioned (1) or (2), when the demand response is a second demand response that increases consumption of electric power in the electric power system, the resource priority determining part sets the resource priority of the battery, in which the charging and discharging control method in response to the second demand response is a fourth control method that reduces a discharge amount of stored electric power, higher than the resource priority of the battery, in which the method is a third control method that increases the amount of electric power being charged, and sets the final resource priority of the battery whose state of charge is equal to or smaller than a second low state of charge value, in which the charging and discharging control method is the third control method, higher than the final resource priority of the battery, in which the method is the fourth control method.
(4) In the aspect of the above-mentioned (3), when the demand response is a first demand response that reduces consumption of electric power in the electric power system, the resource priority determining part determines the final resource priority in the order of: the battery whose state of charge is equal to or greater than a the first high state of charge value, in which the charging and discharging control method in response to the first demand response is a first control method that increases the discharge amount of stored electric power; the battery in which the charging and discharging control method is a second control method that reduces the amount of electric power being charged; and the battery in which the charging and discharging control method is the first control method.
(5) In the aspect of the above-mentioned (4), when the demand response is a second demand response that increases consumption of electric power in the electric power system, the resource priority determining part determines the final resource priority in the order of: the battery whose state of charge is equal to or smaller than a second low state of charge value in which the charging and discharging control method in response to the second demand response is a third control method that increases the amount of electric power being charged; the battery in which the charging and discharging control method is a fourth control method that reduces a discharge amount of stored electric power; and the battery in which the charging and discharging control method is the third control method.
(6) A charging and discharging management method according to an aspect of the present invention is a charging and discharging management method in a charging and discharging management device configured to manage demand response that adjusts electric power supply and demand in an electric power system by controlling charging and discharging of batteries installed in a plurality of vehicles that are electrically connectible to the electric power system, the charging and discharging management method of causing a computer of the charging and discharging management device to: receive a request of the demand response; acquire information of each of the vehicles and the batteries; determine a priority of the vehicle equipped with the battery that controls the charging and discharging according to the request of the demand response; calculate an amount of resources of electric power secured in the battery of the vehicle that participates in the demand response; determine a resource priority that secures the amount of resources in the battery of the vehicle that participates in the demand response; determine the priority based on at least a number of days elapsed from the demand response in which the vehicle previously participated, information on a participation rate of the vehicle in a past demand response, and the amount of resources secured in the demand response in which the vehicle currently participates; and determine the resource priority based on the priority, and a state of charge of the battery contained in information of the battery of the vehicle that currently participates in the demand response.

According to the aspects of the above-mentioned (1) to (6), it is possible to appropriately determine priority for vehicles participating in demand response.

### BRIEF DESCRIPTION OF THE DRAWINGS

FIG. 1 is a view showing an example of a configuration of a charging and discharging management device according to an embodiment, and an example of a usage environment of a charging and discharging management system including the charging and discharging management device.

FIG. 2 is a functional block diagram showing an example of a configuration of a terminal device according to the embodiment.

FIG. 3 is a flowchart showing an example of a flow of DR participation processing in the charging and discharging management device according to the embodiment.

FIG. 4 is a view showing an example of processing results in each step of DR participation processing in the charging and discharging management device according to the embodiment.

### DETAILED DESCRIPTION OF THE INVENTION

Hereinafter, embodiments of a charging and discharging management device and a charging and discharging management method of the present invention will be described with reference to the accompanying drawings.

### Entire Configuration of Charging and Discharging Management System

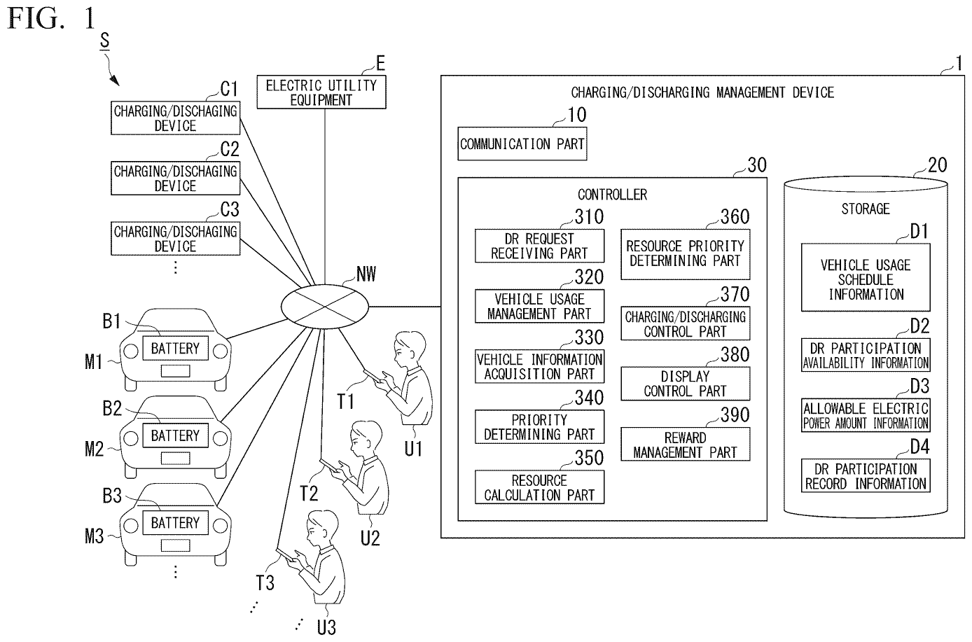

FIG. 1 is a view showing an example of a configuration of a charging and discharging management device according to an embodiment, and an example of a usage environment of a charging and discharging management system including the charging and discharging management device. A charging and discharging management system S is a system that controls demand response (hereinafter also referred to as “DR”), which adjusts the electric power supply and demand in an electric power system (electric power network), by controlling the charging and discharging of the battery using vehicle-to-grid (V2G) technology, which supplies electric power from a storage battery (hereinafter referred to as “battery”) installed in a vehicle to the electric power system (electric power network). The charging and discharging management system S performs control for DR (hereinafter referred to as “DR control”) with respect to a plurality of corresponding vehicles M.

The charging and discharging management system S includes, for example, a charging and discharging management device 1, electric utility equipment E, one or more charging and discharging devices C, one or more vehicles M, and one or more terminal devices T. FIG. 1 shows an example of the charging and discharging management system S configured to perform DR control for each of three vehicles M (vehicles M1 to M3). The charging and discharging management device 1, the electric utility equipment E, the charging and discharging devices C, the vehicles M, and the terminal devices T, which constitute the charging and discharging management system S, are each connected to each other via a network NW so that they can communicate with each other. The network NW may be an arbitrary network, for example, the Internet, a mobile communication network, a wide area network (WAN), a local area network (LAN), a cellular network, etc.

The charging and discharging management device 1 performs overall control of the charging and discharging management system S. The charging and discharging management device 1 controls the charging and discharging of batteries B installed in the vehicle M connected to the charging and discharging device C, for example, in accordance with a demand response plan (hereinafter referred to as a “DR plan”) received from the electric utility equipment E. Details of the charging and discharging management device 1 will be described below.

The electric utility equipment E is used by businesses that supply electricity, such as transmission and distribution companies, retail electricity suppliers, or the like. The electric utility equipment E creates a DR plan based on the electric power supply situation and storage status, and notifies the electric power consumers, such as businesses and households, about DR control. In the charging and discharging management system S, the electric utility equipment E transmits a DR plan to the charging and discharging management device 1 via the network NW.

The charging and discharging devices C are charging and discharging equipment that charges and discharges the batteries B installed in the vehicles M. The charging and discharging device C is installed, for example, at the residence of a user U of the vehicle M or at a public charging station. The charging and discharging devices C charge the batteries B using grid energy supplied from an electric power system (which may be a commercial power source) via a public power grid, or renewable energy generated by a power generation device installed in a residence, etc. The charging and discharging devices C discharge the electric power stored in the batteries B by returning it to the electric power system via the power grid. FIG. 1 shows three charging and discharging devices C (the charging and discharging devices C1 to C3) corresponding to the vehicles M1 to M3, respectively. The charging and discharging device C1 corresponds to the vehicle M1, and performs charging and discharging of the battery B1 mounted on the vehicle M1. Similarly, the charging and discharging device C2 corresponds to the vehicle M2, the charging and discharging device C3 corresponds to the vehicle M3, and they perform charging and discharging of the batteries B (i.e., the battery B2 or the battery B3) mounted on the corresponding vehicles M.

The vehicles M are electric vehicles (EV) that run on electric motors driven by electric power supplied from the batteries B for traveling, which are secondary batteries. The vehicles M include not only four-wheeled vehicles, but also saddle-type two-wheeled vehicles, three-wheeled vehicles (including vehicles with one front wheel and two rear wheels as well as vehicles with two front wheels and one rear wheel), further, assisted bicycles, and all vehicles that are powered by electric motors driven by electric power supplied by the batteries B. The vehicles M may be any vehicles that store electricity supplied by the electric utility equipment E through at least the charging and discharging devices C in the batteries B. That is, the vehicles M are not limited to battery electric vehicles (BEVs), but may also be, for example, hybrid electric vehicles (HEVs), which run on a combination of electric power supplied from the batteries B and electric power supplied by an operation of an internal combustion engine that uses fuel such as a diesel engine or gasoline engine as its energy source.

The vehicle M is used by for example, a user U (hereinafter, also referred to as a “driver”). When the user U returns home, he or she connects (mates) a charging plug of the charging and discharging device C installed in the home with a charging port of the vehicle M, thereby enabling charging and discharging of the vehicle M. Alternatively, the user U goes to a charging station and connects (mates) the charging plug of the charging and discharging device C installed at the charging station to the charging port of the vehicle M, thereby enabling charging and discharging of the vehicle M.

The terminal device T is used, for example, by the user U. The terminal device T is a portable terminal device such as a smartphone or tablet. The terminal device T may be, for example, a general-purpose personal computer (PC) or the like. The terminal device T may be connected to the vehicle M and function as an on-board device. In response to the operation by the user U, the terminal device T performs a procedure to have the vehicle M participate in the DR. The terminal device T executes a pre-installed demand response application (hereinafter referred to as “DR application”) to realize various functions that allow the vehicle M to participate in the DR. The DR application transmits the information input by the operation of the user U to the charging and discharging management device 1 or the like. The DR application notifies the user U by displaying an image based on the information transmitted from the charging and discharging management device 1 on a display device. These various functions may be realized using a general-purpose application program such as a web browser running on the terminal device T. FIG. 1 shows the three terminal devices T (the terminal devices T1 to T3) used by the users U (the users U1 to U3) of each of the vehicles M1 to M3. The terminal device T1 is used by the user U1 of the vehicle MI to perform procedures to have the vehicle M1 participate in the DR. Similarly, the terminal device T2 is used by the user U2 of the vehicle M2, the terminal device T3 is used by the user U3 of the vehicle M3, and they perform procedures to have the corresponding vehicle M (i.e., the vehicle M2 or the vehicle M3) participate in the DR. Details of the terminal device T will be described below.

### Configuration of Charging and Discharging Management Device

Next, a configuration of the charging and discharging management device 1 will be described in detail. The charging and discharging management device 1 includes, for example, a communication part 10, a storage 20, and a controller 30.

The communication part 10 is a communication interface such as a network card for connecting to the network NW. The communication part 10 communicates with external devices such as the electric utility equipment E, the charging and discharging devices C, the terminal devices T, the vehicles M, and the like, via the network NW. The communication part 10 receives the DR plan transmitted by the electric utility equipment E via the network NW and outputs a demand response request (hereinafter referred to as the “DR request”) indicated in the received DR plan to the controller 30. The communication part 10 receives information transmitted by the terminal devices T and the vehicles M via the network NW, and outputs each received piece of information to the controller 30. The communication part 10 transmits control information (control signal) to each of the charging and discharging devices C connected to the vehicles M participating in the DR (their charging ports are mated to the vehicles M) via the network NW to control the charging and discharging of the batteries B in response to the DR request. The communication between the vehicles M and the terminal devices T in the communication part 10 is wireless communication. The communication between the electric utility equipment E and the charging and discharging devices C in the communication part 10 may be wireless communication or wired communication.

The storage 20 stores various types of information necessary for DR control. The storage 20 may be realized, for example, by a semiconductor memory element such as a read only memory (ROM), a random access memory (RAM), an electrically erasable programmable read only memory (EEPROM), or a flash memory, or a storage device (a storage device with a non-transitory storage medium) such as a hard disk drive (HDD). The storage 20 may be realized by another storage device connected via the network NW, such as an external storage server device. The storage 20 stores, for example, vehicle usage schedule information D1, DR participation availability information D2, allowable electric power amount information D3, DR participation record information D4, and the like. The vehicle usage schedule information D1 is information regarding the user U's planned use of the vehicles M (hereinafter referred to as the “vehicle usage schedule”). The DR participation availability information D2 is information that represents the participation availability of the vehicle M in DR (hereinafter referred to as “DR participation availability”). The allowable electric power amount information D3 is information regarding the electric power amount that the vehicle M is allowed to use when participating in DR (hereinafter referred to as “allowable electric power amount”). The DR participation record information D4 is information regarding the participation record of the vehicle M (or the user U) in the DR (i.e., DR participation history).

The controller 30 controls the overall operation of the charging and discharging management device 1. The controller 30 includes, for example, a DR request reception part 310, a vehicle usage management part 320, a vehicle information acquisition part 330, a priority determining part 340, a resource calculation part 350, a resource priority determining part 360, a charging and discharging control part 370, a display control part 380, and a reward management part 390.

Each of the DR request reception part 310, the vehicle usage management part 320, the vehicle information acquisition part 330, the priority determining part 340, the resource calculation part 350, the resource priority determining part 360, the charging and discharging control part 370, the display control part 380, and the reward management part 390 is realized by executing a program (software) using a hardware processor (computer) such as a central processing unit (CPU) or the like. Some or all of these components may be realized by hardware (a circuit part: including circuitry) such as a large scale integration (LSI), a system on chip (SOC), an application specific integrated circuit (ASIC), a programmable logic device (for example, a simple programmable logic device (SPLD), a complex programmable logic device (CPLD), or a field programmable gate array (FPGA)), a graphics processing unit (GPU), or the like, or cooperation of software and hardware. Some or all of these components may be realized by a dedicated LSI. The program may, for example, be stored in advance in a storage device (a storage device with a non-transitory storage medium) such as a semiconductor memory element such as ROM, RAM, EEPROM, or flash memory, or a hard disk drive (HDD), or may be stored in a removable storage medium (a non-transitory storage medium) such as a DVD or CD-ROM, and may be installed in the storage device when the storage medium is inserted into a drive device.

The charging and discharging management device 1 is not limited to a single device, but may be a plurality of devices working together to realize each functional configuration part in the controller 30. That is, some or all of the functional configuration parts included in the controller 30 of the charging and discharging management device 1 may be included in another device. For example, each functional configuration part in the controller 30 may be realized by communication and cooperation between the charging and discharging management device 1 and other devices (such as a server device or the like).

The DR request reception part 310 receives a DR request transmitted by the electric utility equipment E via the network NW and output by the communication part 10. The DR requests include, for example, “downward DR” requests, which control consumers to suppress (reduce) their electric power consumption during peak electric power demand periods, thereby balancing the overall supply and demand of electric power, and “upward DR” requests, which control consumers to consume more electric power supplied by the electric power system, thereby increasing the consumption of electric power and balancing the overall supply and demand of electric power. When the DR request reception part 310 receives a DR request from the electric utility equipment E, the charging and discharging management device 1 starts processing (hereinafter referred to as “DR participation processing”) to have the vehicle M participate in the DR in response to the DR request. That is, the reception of the DR request in the DR request reception part 310 triggers the charging and discharging management device 1 to start the DR participation processing. When the DR request is the downward DR, the DR participation processing in the charging and discharging management device 1 controls the charging and discharging of the batteries B so as to reduce the amount of electric power charged to the batteries B installed in the vehicle M or increase the amount of electric power discharged from the batteries B. Meanwhile, when the DR request is the upward DR, the DR participation processing in the charging and discharging management device 1 controls the charging and discharging of the batteries B so as to increase the amount of electric power charged to the batteries B installed in the vehicle M, or to reduce the amount of electric power discharged from the batteries B.

The DR request reception part 310 is an example of a “demand response request reception part.” The downward DR is an example of a “first demand response,” and the upward DR is an example of a “second demand response.”

The vehicle usage management part 320 manages information related to the user U's use of the vehicle M. For example, the vehicle usage management part 320 acquires information about the vehicle usage schedule entered by the user U by operating the terminal devices T, which is transmitted by the terminal devices T via the network NW and output by the communication part 10, associates the acquired vehicle usage schedule with the user U (or the vehicles M), and registers it in the vehicle usage schedule information D1 stored in the storage 20. For example, the vehicle usage management part 320 acquires information representing the DR participation availability entered by the user U by operating the terminal devices T, which is transmitted by the terminal devices T via the network NW and output by the communication part 10, associates the acquired DR participation availability information with the user U (or the vehicles M), and registers it in the DR participation availability information D2 stored in the storage 20. For example, the vehicle usage management part 320 acquires the information on the allowable electric power amount entered by the user U by operating the terminal devices T, which is transmitted by the terminal devices T via the network NW and output by the communication part 10, associates the acquired allowable electric power amount with the user U (or the vehicles M), and registers it in the allowable electric power amount information D3 stored in the storage 20.

The vehicle information acquisition part 330 acquires various types of information related to the vehicles M and the batteries B. More specifically, the vehicle information acquisition part 330 acquires information related to the batteries B installed in the vehicles M and information representing the status of the vehicles M, which is transmitted by the vehicles M via the network NW and output by the communication part 10. For example, the vehicle information acquisition part 330 acquires information about the state of charge (SOC) of the batteries B, that is, information about the remaining electric power capacity of the batteries B. The vehicle information acquisition part 330 may acquire information such as the electric power capacity (maximum electric power capacity) that can be stored in the batteries B and information on the state of health (SOH) of the batteries B from the vehicles M. For example, the vehicle information acquisition part 330 acquires information indicating whether the charging port of the charging and discharging devices C is connected to the vehicle M (whether it is mated or not). The vehicle information acquisition part 330 may associate the acquired information related to the batteries B and information representing the status of the vehicles M with the user U (or the vehicles M) and store it in the storage 20. In the following description, the term “vehicle information” is used interchangeably to refer to information related to the batteries B and information representing the status of the vehicles M acquired by the vehicle information acquisition part 330.

The vehicle information acquisition part 330 is an example of the “vehicle information acquisition part.”

The priority determining part 340 determines the priority of each of the vehicles M (i.e., the batteries B installed in the vehicles M) when participating in the DR in response to the DR request. Here, the priority determining part 340 determines the priority for the participation of the vehicles M in the DR based on the respective information regarding the use of the vehicles M obtained by the vehicle usage management part 320 (which may be the respective information of the vehicle usage schedule information D1, the DR participation availability information D2, and the allowable electric power amount information D3 stored in the storage 20) and the respective information regarding the vehicles M or the batteries B obtained by the vehicle information acquisition part 330. The method of determining priority in the priority determining part 340 may be, for example, to score various items such as the number of days elapsed (or may be elapsed time) since the previous DR in which the vehicle M participated, information on the participation rate in the DR, such as the percentage of the vehicle M's status that allowed participation in the DR in past DRs (i.e., the percentage of the vehicle M's charging port connected to the charging and discharging device C in the past DRs), and the amount of electric power that can be charged or discharged in the DR (amount of electric power resources), and to determine the priority in descending order of the total score. More specifically, each item is scored so that as the number of days elapsed since the previous DR for each vehicle M is increased, the score is increased; as the time that the charging port of the charging and discharging devices C was connected (mated) during the previous DR implementation period (higher participation rate in DR) is increased, the score is increased; and as the amount of electric power that can respond to DR is increased, the score is increased. Then, the priority determining part 340 assigns priorities from highest to lowest in descending order of the total score of all items.

The method of determining priority in the priority determining part 340 is not limited to the points mentioned above, and any method may be used as long as it can determine the order in which each of the vehicles M participates in the DR. For example, alternatively, the scores for each of the above-mentioned items may be multiplied by a predetermined coefficient for each item, and the priorities may be assigned from highest to lowest in descending order of the sum of the results. The priority determining part 340 outputs to the resource priority determining part 360 the priority information to be used when the determined vehicle M (i.e., the batteries B installed in the vehicle M) is allowed to participate in the DR (hereinafter referred to as “priority information”).

The priority determining part 340 is an example of the “priority determining part.”

The resource calculation part 350 calculates the amount of electric power resources that can be secured for each vehicle M when participating in a DR in response to a DR request (hereinafter referred to as the “secured amount of resources”). Here, the resource calculation part 350 calculates the secured amount of resources based on the allowable electric power amount obtained by the vehicle usage management part 320 (which may be the information in the allowable electric power amount information D3 stored in the storage 20) or the respective information about the batteries B installed in the vehicles M obtained by the vehicle information acquisition part 330 (for example, information about the SOC of the batteries B, the maximum electric power capacity of the batteries B, and the SOH of the batteries B).

Here, when the DR request is the downward DR, as described above, the DR participation processing in the charging and discharging management device 1 can secure the amount of electric power resources required for the DR request by reducing the amount of electric power charged to the batteries B installed in the vehicle M or by increasing the amount of electric power discharged from the batteries B. For this reason, when the DR request is the downward DR, the resource calculation part 350 calculates the secured amount of resources that can be secured by reducing the amount of electric power charged to the batteries B and the secured amount of resources that can be secured by increasing the amount of electric power discharged from the batteries B. Meanwhile, when the DR request is the upward DR, as described above, in the DR participation processing in the charging and discharging management device 1, the amount of electric power resources corresponding to the DR request can be secured by increasing the amount of electric power charged to the batteries B or reducing the amount of electric power discharged from the batteries B. For this reason, when the DR request is the upward DR, the resource calculation part 350 calculates the secured amount of resources that can be secured by increasing the amount of electric power charged to the batteries B and the secured amount of resources that can be secured by reducing the amount of electric power discharged from the batteries B.

The method for calculating the secured amount of resources in the resource calculation part 350 is not limited to the above-mentioned method, and any method may be used as long as it can calculate (find) the amount of electric power (secured amount of resources) that is increased or decreased by controlling the charging and discharging of the batteries B for the purpose of the DR. The resource calculation part 350 outputs information about the calculated secured amount of resources to the resource priority determining part 360.

The resource calculation part 350 is an example of the “resource calculation part.”

Based on the priority information output by the priority determining part 340 and the secured amount of resources output by the resource calculation part 350, the resource priority determining part 360 determines the final priority of the vehicle M (i.e., the batteries B installed in the vehicle M) that controls charging and discharging to ensure the electric power amount (secured amount of resources) corresponding to this DR request. The final priority determined by the resource priority determining part 360 is the priority of charging and discharging control performed to ensure the amount of electric power (secured amount of resources) according to the DR request. In the following description, in order to distinguish between the priority of (the vehicle M) determined by the priority determining part 340 and the priority of the final charging and discharging control determined by the resource priority determining part 360, the priority of the charging and discharging control determined by the resource priority determining part 360 is referred to as the “resource priority.”

Incidentally, when the DR request is the downward DR, as described above, the resource calculation part 350 calculates the secured amount of resources that can be secured by reducing the amount of electric power charged to the batteries B and the secured amount of resources that can be secured by increasing the amount of electric power discharged from batteries B. That is, the resource calculation part 350 calculates the secured amount of resources for each control method when the charging and discharging control method in the DR (hereinafter referred to as the “DR control method”) used to secure the amount of electric power required for the DR request is a charging reduction control method that reduces the amount of electric power charged to batteries B, or a discharging increase control method that increases the amount of discharge of the electric power stored in batteries B. Meanwhile, when the DR request is the upward DR, as described above, the resource calculation part 350 calculates the secured amount of resources that can be secured by increasing the amount of electric power charged to the batteries B and the secured amount of resources that can be secured by reducing the amount of electric power discharged from batteries B. That is, the resource calculation part 350 calculates the amount of resources secured for each DR control method: a charging increase control method that increases the amount of electric power charged to batteries B, and a discharging reduction control method that reduces the amount of electric power discharged from batteries B. For this reason, the resource priority determining part 360 determines the resource priority, assuming that the secured amounts of resources in each DR control method are different. Here, when the DR request is the downward DR, the resource priority determining part 360 determines that the charging reduction control method has a higher resource priority than the discharging increase control method for the same batteries B. Meanwhile, when the DR request is the upward DR, the resource priority determining part 360 determines that the discharging reduction control method has a higher resource priority than the charging increase control method for the same batteries B. This because the charging reduction control method and the discharging reduction control method, which allow the batteries B to participate in the DR by reducing the amount of electric power charged to the batteries B and reducing the amount of electric power discharged from the batteries B (i.e., not charging and discharging batteries B), place less a load on batteries B than the discharging increase control method and the charging increase control method, which allow the batteries B to participate in DR by increasing the amount of electric power discharged from the batteries B and increasing the amount of electric power charged to the batteries B (i.e., charging and discharging batteries B). Then, this because a lower load on the batteries B contributes to a lower SOH of batteries B, that is, to suppressing (slowing down) the deterioration of the batteries B.

Then, the resource priority determining part 360 determines the final resource priority for controlling charging and discharging by checking the SOC information of the batteries B installed in each of the vehicles M obtained by the vehicle information acquisition part 330. More specifically, when the DR request is the downward DR, the resource priority determining part 360 checks whether there are any batteries B whose SOC is equal to or greater than the predetermined high SOC value (for example, 95% or greater), and increases the final resource priority of the batteries B whose SOC is equal to or greater than the high SOC value. Meanwhile, when the DR request is the upward DR, the resource priority determining part 360 checks whether any of the batteries B have a SOC equal to or smaller than the predetermined low SOC value (for example, 30% or less) and increases the final resource priority of the batteries B whose SOC is equal to or smaller than the low SOC value. That is, the resource priority determining part 360 changes (replaces) the resource priority of the batteries B. Accordingly, this can shorten the time that the SOC of batteries B is equal to or greater than the high SOC value or equal to or smaller than the low SOC value, i.e., the maintenance time when the SOC is equal to or greater than the high SOC value or equal to or smaller than the low SOC value, and contribute to suppressing the decrease in the SOH of the batteries B (slowing down the deterioration of the batteries B).

The resource priority determining part 360 outputs information on the determined final resource priority (hereinafter referred to as “final resource priority information”) to the charging and discharging control part 370. The final resource priority information indicates, for example, the resource priority information only for the vehicle M that is currently participating in the DR in response to the DR request.

The resource priority determining part 360 is an example of the “resource priority determining part.” The discharging increase control method is an example of a “first control method,” and the charging reduction control method is an example of a “second control method.” The charging increase control method is an example of a “third control method,” and the discharging reduction control method is an example of a “fourth control method.” The predetermined high SOC value (for example, 95%) is an example of a “first state of charge value,” and the predetermined low SOC value (for example, 30%) is an example of a “second state of charge value.”

The charging and discharging control part 370 controls the charging and discharging of the batteries B based on the final resource priority information output by the resource priority determining part 360. More specifically, the charging and discharging control part 370 outputs charging and discharging control information (control signal) to the communication part 10 for the charging and discharging device C to which the vehicle M indicated in the final resource priority information is connected (the charging port is mated), and transmits the control information (control signal) output to each of the charging and discharging device C via the network NW. Accordingly, the charging and discharging devices C to which the control information (control signal) is transmitted control the charging and discharging of the batteries B installed in the vehicles M in response to the DR request. The charging and discharging control part 370 associates the user U (or the vehicle M) with the information indicating that the vehicle M, which transmitted the control information (control signal), has participated in the DR, and registers this information in the DR participation record information D4 stored in the storage 20. The DR participation record information D4 includes, for example, information on the date and time of participation in the DR, information indicating whether it is a downward DR or an upward DR, and information such as the amount of electric power secured by the DR (secured amount of resources), which is registered as a history of participation in the DR.

The charging and discharging control part 370 is an example of the “charging and discharging control part.”

The display control part 380 controls the display device of the terminal device T to display information. The display control part 380 generates notification information to notify the user U based on the processing results of various functions of the controller 30, outputs the generated notification information to the communication part 10, and transmits it to the corresponding terminal device T via the network NW. The notification information may be an image that the DR application running on the terminal device T displays on the display device as notification information, or may be information that the DR application generates an image to be displayed on the display device. Accordingly, the user U can check various types of information about the DR through the notification information displayed on the display device of the terminal device T.

The display control part 380 is an example of the “display control part.”

The reward management part 390 manages the reward paid to the users U based on the results of their participation in the DR, i.e., their participation record in the exchange of electric power between the batteries B and an external electric power source (for example, an electric power system or an electric power trading market). The reward management part 390 provides that a reward will be granted to the user U not only when the vehicle M participates in the exchange of electric power, but also when the vehicle M is ready to participate in the exchange of electric power (i.e., when the information indicating DR participation availability indicates that the vehicle M is able to participate in DR), but when the DR participation processing in the controller 30 described above does not ultimately result in participation in DR. Here, the reward management part 390 may set the reward to the user U when waiting to participate in the DR lower than the reward to the user U when the vehicle M actually participates in the DR.

### Configuration of Terminal Device

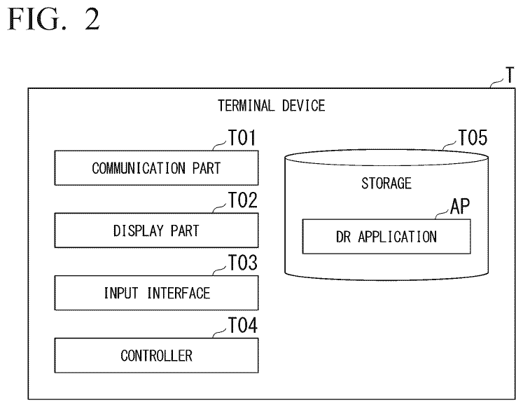

FIG. 2 is a functional block diagram showing an example of a configuration of the terminal device T according to the embodiment. The terminal device T includes, for example, a communication part T01, a display part T02, an input interface T03, a controller T04, and a storage T05. FIG. 2 omits the illustration of other components in the terminal device T that realize functions unrelated to the function of performing procedures to have the vehicle M participate in the DR in response to the operations by the user U, but the components included in the terminal device T are not limited to the components described above and may also have other components. For example, the terminal device T may have components such as an output interface configured to notify the user U of various types of information.

The communication part TO1 is a communication interface such as a network card for connecting to the network NW, or the like. The communication part T01 communicates with external devices such as the charging and discharging management device 1, the electric utility equipment E, the charging and discharging device C, the vehicle M, and the like, via the network NW.

The display part T02 displays various types of information related to DR control in the charging and discharging management system S. The display part T02 is, for example, a liquid crystal display (LCD) or an organic electroluminescence (EL) display. The display part T02 displays the image generated by the controller T04 or a graphical user interface (GUI) for receiving various input operations from the user U.

The input interface T03 receives various input operations from the user U, converts the received input operations into electrical signals, and outputs them to the controller T04. The input interface T03 includes, for example, a touch panel, a keyboard, a mouse, and the like.

The controller T04 controls the entire operations of the terminal device T. The controller T04, for example, executes a demand response application (hereinafter referred to as “DR application”) AP stored in the storage T05, thereby realizing various functions for participating in DR control. The controller T04 provides functions such as an input function for inputting information such as the vehicle usage schedule and DR participation availability, a setting function for setting the allowable electric power amount, and a reward management function for managing rewards obtained through participation in DR.

The storage T05 stores various types of information related to DR. The storage T05 is realized, for example, by a semiconductor memory element such as ROM, RAM, EEPROM, or flash memory, or a storage device (a storage device with a non-transitory storage medium) such as a hard disk drive (HDD) or the like. The storage T05 stores, for example, a DR application AP to be executed in the terminal devices T to allow the vehicles M to participate in the DR.

### Flow of Entire Processing in Charging and Discharging Management Device

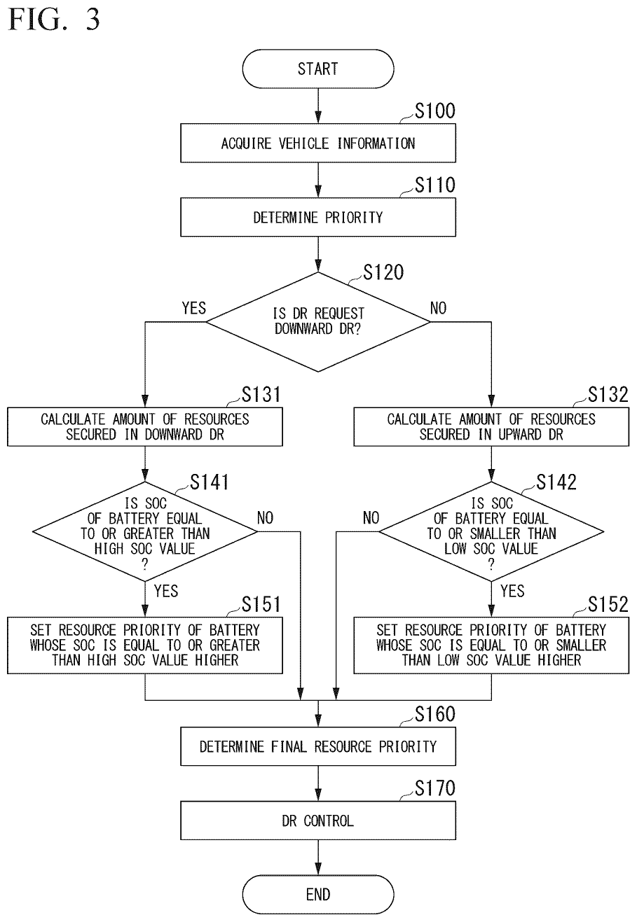

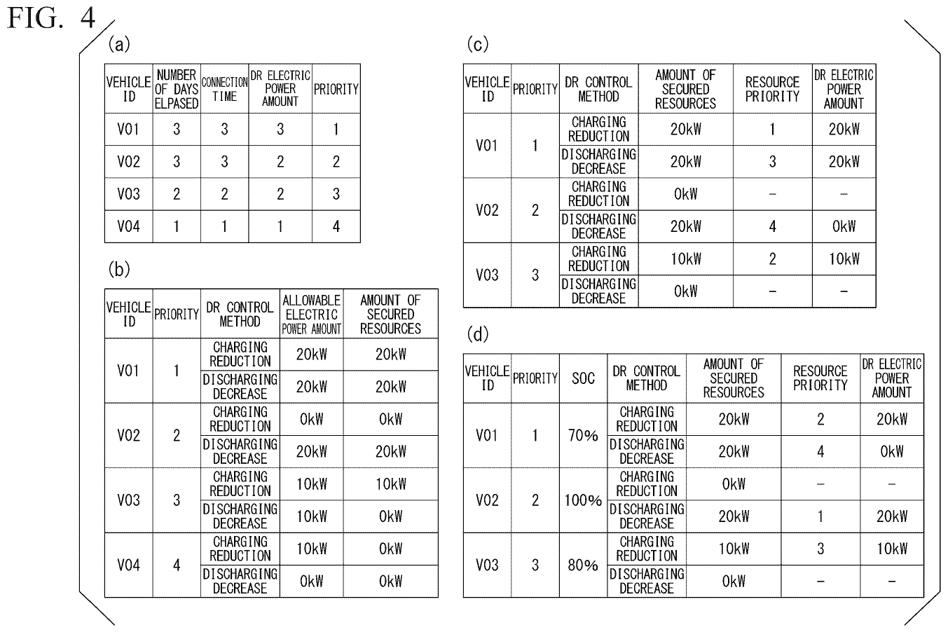

Next, an example of the DR participation processing in the charging and discharging management device 1 will be described. FIG. 3 is a flowchart showing an example of a flow of the DR participation processing in the charging and discharging management device 1 according to the embodiment. FIG. 4 is a view showing an example of processing results in each step of the DR participation processing in the charging and discharging management device 1 according to the embodiment. FIG. 4 shows an example of the processing results for each step when the DR request is, for example, a downward DR of 50 [kW] after two hours. In the following description, the DR participation processing in the charging and discharging management device 1 will be described with reference to an example of processing results at each step of the DR participation processing shown in FIG. 4 as appropriate.

In the following description, it is assumed that the vehicle usage management part 320 has already acquired information on the vehicle usage schedule, DR participation availability, and allowable electric power amount corresponding to each of the vehicles M, and has stored (registered) the information in the storage 20 as the vehicle usage schedule information D1, the DR participation availability information D2, and the allowable electric power amount information D3.

As described above, the DR participation processing shown in FIG. 3 begins when the DR request reception part 310 receives the DR plan (DR request) transmitted by the electric utility equipment E. When the DR participation processing is started, first, the vehicle information acquisition part 330 acquires vehicle information of the vehicles M that can participate in DR of the DR request (step S100). More specifically, the vehicle information acquisition part 330 acquires vehicle information of the vehicles M, which are not scheduled for use by the user U in two hours in the vehicle usage schedule information D1 and are available to participate in DR in the DR participation availability information D2.

Next, the priority determining part 340 determines the priority of each of the vehicles M to be allowed to participate in the DR in response to the DR request (step S110).

Part (a) of FIG. 4 shows an example of the priority determined by the priority determining part 340 in the step. In the example shown in part (a) of FIG. 4, it is assumed that four vehicles M with identification information (vehicle ID) ID=V01 to V04 are eligible to participate in DR, the items of “number of days elapsed,” “connection time,” and “DR electric power amount” for each of the vehicles M are scored, and the vehicle M with the highest total score for all items is assigned priority=1, and priorities of 1 to 4 are then determined for all of the vehicles M in order of their total scores. The “number of days elapsed” item is the number of days elapsed since the DR in which the vehicle M previously participated. The “connection time” item is the length of time that the vehicle M was connected (mated) to the charging port of the charging and discharging device C during the past DR implementation period, and represents the participation rate in past DR. The “DR electric power amount” item is the amount of electric power that can be charged/discharged by participating in DR. In the example shown in part (a) of FIG. 4, the priority of the vehicle M with ID=V01 is the highest priority=1, the priority of the vehicle M with ID=V02 is the next priority=2, the priority of the vehicle M with ID=V03 is the next priority=3, and the priority of the vehicle M with ID=V04 is the lowest priority=4.

Then, the priority determining part 340 outputs priority information indicating the determined priority to the resource priority determining part 360.

Next, the resource calculation part 350 determines whether the DR request is a downward DR (step S120). In step S120, when it is determined that the DR request is the downward DR, the resource calculation part 350 calculates the secured amount of resources that can be secured by each of the vehicles M participating in the downward DR (step S131).

Part (b) of FIG. 4 shows an example of the secured amount of resources calculated by the resource calculation part 350 in the step. In the example shown in part (b) of FIG. 4, since the DR request is the downward DR, the secured amount of resources for each vehicle M is calculated when the DR control method is “charging reduction” and when the DR control method is “discharging increase.” In part (b) of FIG. 4, the “allowable electric power amount” is an example of the allowable electric power amount registered in the allowable electric power amount information D3, that is, the electric power amount allowed by the user U. The “allowable electric power amount” in part (b) of FIG. 4 may be, for example, an amount obtained by multiplying the allowable electric power amount registered in the allowable electric power amount information D3 by a coefficient based on information such as the SOC, maximum electric power capacity, and SOH of the batteries B. The resource calculation part 350 calculates the secured amount of each resource within a range of the “allowable electric power amount.”

Then, the resource calculation part 350 outputs the information representing the calculated secured amount of resources to the resource priority determining part 360.

Next, the resource priority determining part 360 checks the SOC information of the batteries B installed in each of the vehicles M contained in the vehicle information acquired by the vehicle information acquisition part 330 and determines whether there are any batteries B whose SOC is equal to or greater than the high SOC value (step S141). In step S141, when it is determined that there are no batteries B whose SOC is equal to or greater than the high SOC value, the resource priority determining part 360 proceeds to step S160.

Meanwhile, in step S141, when it is determined that there are batteries B whose SOC is equal to or greater than the high SOC value, the resource priority determining part 360 increases the resource priority of the batteries B whose SOC is equal to or greater than the high SOC value in the priority information output by the priority determining part 340 (step S151).

Part (c) of FIG. 4 shows an example of determining resource priority before processing step S151, i.e., before processing step S141, which determines whether there are any batteries B whose SOC is equal to or greater than the high SOC value. In the example shown in part (c) of FIG. 4, when responding to a DR request for 50 kW of downward DR, as described above, resource priority is first assigned to the charging reduction control method for each battery B, and then to the discharging increase control method. More specifically, in the example shown in part (c) of FIG. 4, the DR control method=charging reduction for vehicle ID=V01 is assigned the highest resource priority=1, ensuring a downward DR electric power amount (DR electric power amount) of 20 [kW], the DR control method=charging reduction for vehicle ID=V03 is assigned the next resource priority=2, ensuring a DR electric power amount of the downward DR=10 [kW], and since there are no secured amounts of resources for the other DR control method=charging reduction, the DR control method=discharging increase for vehicle ID=V01 is assigned the next resource priority=3, ensuring a DR electric power amount of the downward DR=20 [kW], thereby achieving a total downward DR of 50 [kW]. In the example shown in part (c) of FIG. 4, the next vehicle ID=V02, which can be assigned the next resource priority=4, has a DR control method=discharging increase, and the previous downward DR has secured a DR electric power amount=50 [kW], so the DR electric power amount=0 [kW]. The example of the resource priority determination method shown in part (c) of FIG. 4 can be said to correspond to the priority determination method in the related art.

On the other hand, the resource priority determining part 360 changes (replaces) the resource priority in the processing of step S151 so as to increase the resource priority of the batteries B whose SOC is equal to or greater than the high SOC value. Part (d) of FIG. 4 shows an example of changing (replacing) the resource priority of the batteries B whose SOC is equal to or greater than the high SOC value in the processing of step S151. In the example shown in part (d) of FIG. 4, it is assumed that the SOC of the battery B installed in the vehicle M with vehicle ID=V02 is 100%, in the example shown in part (c) of FIG. 4, the DR control method =discharging increase for vehicle ID=V02, which had a DR electric power amount=0 [kW], is given the highest resource priority=1, and the DR electric power amount of the downward DR=20 [kW] is secured, and the other resource priorities are lowered one by one. More specifically, in the example shown in part (d) of FIG. 4, the DR control method=charging reduction for vehicle ID=V01 in the example shown in part (c) of FIG. 4, which had resource priority=1, is downgraded to resource priority=2, ensuring a DR electric power amount of 20 [kW] for downward DR, and the DR control method=charging reduction for vehicle ID=V03 in the example shown in part (c) of FIG. 4, which had resource priority=2, is downgraded to resource priority=3, ensuring a DR electric power amount of 10 [kW] for downward DR, thereby achieving a total downward DR of 50 [kW]. Then, in the example shown in part (d) of FIG. 4, as a result of securing a DR electric power amount of 20 [kW] for downward DR by changing (replacing) the DR control method=discharging increase for vehicle ID=V02, which has been changed to resource priority=1, the DR electric power amount for downward DR that can be secured by changing the DR control method=discharging increase for vehicle ID=V01, which has been lowered to resource priority=4, is now DR electric power amount=0 [kW]. In this way, by changing (replacing) the resource priority of batteries B whose SOC is equal to or greater than the high SOC value before the resource priority determining part 360 determines the final resource priority, the maintenance time for batteries B whose SOC is equal to or greater than the high SOC value can be shortened, and the deterioration of SOH can be suppressed (deterioration of batteries B can be slowed) while allowing batteries B to participate in DR.

Then, the resource priority determining part 360 proceeds to step S160.

Meanwhile, in step S120, when it is determined that the DR request is not a downward DR, that is, an upward DR, the resource calculation part 350 calculates the secured amount of resources that can be secured for each of the vehicles M participating in the upward DR (step S132).

An example of the secured amount of resources calculated by the resource calculation part 350 in this step can be similarly considered by replacing the DR control method in the example for downward DR shown in part (b) of FIG. 4 with the DR control method for upward DR. More specifically, the same can be considered by replacing the “charging reduction” in the example of downward DR shown in part (b) of FIG. 4 with “discharging reduction” and the “discharging increase” with “charging increase.” The resource calculation part 350 calculates the secured amount of each resource within the range of the “allowable electric power amount,” as in the case of the downward DR.

Then, the resource calculation part 350 outputs information representing the calculated secured amount of resources to the resource priority determining part 360.

Next, the resource priority determining part 360 checks the SOC information of the batteries B installed in each of the vehicles M contained in the vehicle information acquired by the vehicle information acquisition part 330 and determines whether there are any batteries B whose SOC is equal to or smaller than the low SOC value (step S142). In step S142, when it is determined that there are no batteries B whose SOC is equal to or smaller than the low SOC value, the resource priority determining part 360 proceeds to step S160.

Meanwhile, in step S142, when it is determined that there are batteries B whose SOC is equal to or smaller than the low SOC value, the resource priority determining part 360 increases the resource priority of the batteries B whose SOC is equal to or smaller than the low SOC value in the priority information output by the priority determining part 340, as in the case of downward DR (step S152).

An example of the secured amount of resources calculated by the resource calculation part 350 in this step can be similarly considered by replacing the DR control method for downward DR of the example shown in part (c) of FIG. 4 and part (d) of FIG. 4 with the DR control method for upward DR. More specifically, the same can be considered by replacing “charging reduction” with “discharging reduction” and “discharging increase” with “charging increase” in the example of downward DR shown in part (c) of FIG. 4 and part (d) of FIG. 4, and by replacing the SOC of vehicle ID=V02 in the example of downward DR shown in part (d) of FIG. 4 with, for example, 25%. Then, even in the case of upward DR, the DR control method=charging increase for vehicle ID=V02, which had resource priority=4, becomes the highest resource priority=1. In this way, in the case of upward DR, the resource priority determining part 360 changes (replaces) the resource priority of batteries B, whose SOC is equal to or smaller than the low SOC value, to a higher value before determining the final resource priority, thereby shortening the maintenance time for batteries B, whose SOC is equal to or smaller than the low SOC value, and allowing the batteries B to participate in DR while suppressing the decrease in SOH (slowing the deterioration of the batteries B).

Then, the resource priority determining part 360 proceeds to step S160.

The resource priority determining part 360 determines the final resource priority after the resource priority change (replacement) (step S160). The resource priority determining part 360 outputs information about the determined final resource priority (final resource priority information) to the charging and discharging control part 370.

The charging and discharging control part 370 performs DR control of the batteries B based on the final resource priority information output by the resource priority determining part 360 (step S170). More specifically, the charging and discharging control part 370 outputs control information (control signal) of the DR control to the communication part 10 and transmits it to the charging and discharging devices C. Accordingly, the charging and discharging devices C perform the DR control in response to a DR request for the batteries B installed in the vehicles M.

After that, the display control part 380 outputs notification information to the communication part 10 to notify the user U of the results of the DR control and transmits it to the terminal devices T. Further, the reward management part 390 causes the DR to output information on the reward to be paid to the user U as a result of participation to the communication part 10 and transmit it to the terminal devices T. Accordingly, the user U can check the results of DR control and the information on the reward he/she can get through the terminal devices T.

With this configuration and processing (DR participation processing), the charging and discharging management device 1 determines the final resource priority when the vehicle M participates in the DR in response to the DR request, so as to shorten the maintenance time when the SOC of the batteries B is equal to or greater than a predetermined high SOC value or equal to or smaller than a low SOC value. Accordingly, the charging and discharging management device 1 allows the batteries B installed in the vehicle M to participate in DR while suppressing the decrease in SOH (slowing down the deterioration of the batteries B).

As described above, according to the embodiment, the charging and discharging management device 1 controls the charging and discharging (DR control) of the batteries B installed in the vehicles M connected to the charging and discharging devices C in response to a demand response request (DR request) indicated in the demand response plan (DR plan) received from the electric utility equipment E, that is, determines the priority of the batteries B to participate in the demand response. Then, in the embodiment, the charging and discharging management device 1 changes (replaces) the resource priority of the batteries B that participate in demand response and the demand response control method (DR control method) based on the state of charge (SOC) information acquired from the batteries B. Here, in the charging and discharging management device 1 of the embodiment, the resource priority of the batteries B is increased when the SOC of the batteries B is equal to or greater than the predetermined high SOC value or equal to or less than the low SOC value. Accordingly, in the charging and discharging management device 1 of the embodiment, the maintenance time for the batteries B equal to or greater than the high SOC value or equal to or smaller than the low SOC value can be shortened. As a result, in the embodiment, the charging and discharging management device 1 can allow the batteries B to participate in demand response while suppressing the decrease in the state of health (SOH) of the batteries B (suppressing (slowing down) the deterioration of the batteries B). That is, in the charging and discharging management device 1 of the embodiment, the priority (including resource priority) of the vehicles M (the batteries B) that are to participate in the demand response can be suitably determined. As a result, the user U who uses the vehicles M managed by the charging and discharging management device 1 of the embodiment can use the vehicles M without suffering any disadvantage even if the batteries B installed in the vehicles M participate in demand response.

The above-mentioned embodiment can be expressed as follows.

A charging and discharging management device configured to manage a demand response to adjust electric power supply and demand in an electric power system by controlling charging and discharging of batteries installed in a plurality of vehicles that can be electrically connected to the electric power system, and provided with a computer including:
a storage medium configured to store computer-readable instructions; and
a processor connected to the storage medium,
the processor executing the computer-readable instructions to:
receive a request of the demand response;
acquire information of each of the vehicles and the batteries;
determine priority the vehicle equipped with the battery that controls the charging and discharging according to the request of the demand response;
calculate an amount of resources of electric power secured in the battery of the vehicle that participates in the demand response;
determine resource priority that secures the amount of resources in the battery of the vehicle that participates in the demand response;
determines the priority based on at least the number of days elapsed from the demand response in which the vehicle previously participated, information on a participation rate of the vehicle in the past demand response, and the amount of resources secured in the demand response in which the vehicle currently participates; and
determine the resource priority based on the priority and a state of charge of the battery contained in information of the battery of the vehicle that currently participates in the demand response.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A charging and discharging management device configured to manage demand response that adjusts electric power supply and demand in an electric power system by controlling charging and discharging of batteries installed in a plurality of vehicles that are electrically connectible to the electric power system, the charging and discharging management device comprising:
a demand response request reception part configured to receive a request of the demand response;
a vehicle information acquisition part configured to acquire information of each of the vehicles and the batteries;
a priority determining part configured to determine priority of the vehicle equipped with the battery that controls the charging and discharging according to a request of the demand response;
a resource calculation part configured to calculate an amount of resources of electric power secured in the battery of the vehicle that participates in the demand response; and
a resource priority determining part configured to determine resource priority that secures the amount of resources in the battery of the vehicle that participates in the demand response,
wherein the priority determining part determines the priority based on at least a number of days elapsed from the demand response in which the vehicle previously participated, information on a participation rate of the vehicle in a past demand response, and the amount of resources secured in the demand response in which the vehicle currently participates, and
the resource priority determining part determines the resource priority based on the priority, and a state of charge of the battery contained in information of the battery of the vehicle that currently participates in the demand response.

2. The charging and discharging management device according to claim 1, wherein, when the demand response is a first demand response that reduces consumption of electric power in the electric power system,
the resource priority determining part sets the resource priority of the battery, in which a charging and discharging control method in response to the first demand response is a second control method that reduces the amount of electric power being charged, higher than the resource priority of the battery, in which the charging and discharging control method is a first control method that increases the discharge amount of stored electric power, and
sets a final resource priority of the battery whose state of charge is equal to or greater than a first high state of charge value, in which the method is the first control method, higher than the final resource priority of the battery, in which the method is the second control method.

3. The charging and discharging management device according to claim 1, wherein, when the demand response is a second demand response that increases consumption of electric power in the electric power system,
the resource priority determining part sets the resource priority of the battery, in which the charging and discharging control method in response to the second demand response is a fourth control method that reduces a discharge amount of stored electric power, higher than the resource priority of the battery, in which the charging and discharging control method is a third control method that increases the amount of electric power being charged, and
sets the final resource priority of the battery whose state of charge is equal to or smaller than a second low state of charge value, in which the method is the third control method, higher than the final resource priority of the battery, in which the method is the fourth control method.

4. The charging and discharging management device according to claim 3, wherein, when the demand response is a first demand response that reduces consumption of electric power in the electric power system,
the resource priority determining part determines the final resource priority in the order of: the battery whose state of charge is equal to or greater than a the first high state of charge value, in which the charging and discharging control method in response to the first demand response is a first control method that increases the discharge amount of stored electric power; the battery in which the charging and discharging control method is a second control method that reduces the amount of electric power being charged; and the battery in which the charging and discharging control method is the first control method.

5. The charging and discharging management device according to claim 4, wherein, when the demand response is a second demand response that increases consumption of electric power in the electric power system,
the resource priority determining part determines the final resource priority in the order of: the battery whose state of charge is equal to or smaller than a second low state of charge value in which the charging and discharging control method in response to the second demand response is a third control method that increases the amount of electric power being charged; the battery in which the charging and discharging control method is a fourth control method that reduces a discharge amount of stored electric power; and the battery in which the charging and discharging control method is the third control method.

6. A charging and discharging management method in a charging and discharging management device configured to manage demand response that adjusts electric power supply and demand in an electric power system by controlling charging and discharging of batteries installed in a plurality of vehicles that are electrically connectible to the electric power system, the charging and discharging management method of causing a computer of the charging and discharging management device to:
receive a request of the demand response;
acquire information of each of the vehicles and the batteries;
determine priority of the vehicle equipped with the battery that controls the charging and discharging according to the request of the demand response;
calculate an amount of resources of electric power secured in the battery of the vehicle that participates in the demand response;
determine resource priority that secures the amount of resources in the battery of the vehicle that participates in the demand response;
determine the priority based on at least a number of days elapsed from the demand response in which the vehicle previously participated, information on a participation rate of the vehicle in a past demand response, and the amount of resources secured in the demand response in which the vehicle currently participates; and
determine the resource priority based on the priority, and a state of charge of the battery contained in information of the battery of the vehicle that currently participates in the demand response.
